(19) United States
(12) Patent Application Publication
(10) Pub. No.: US 2023/0302765 A1
(43) Pub. Date: Sep. 28, 2023

(54) OPTIMIZED SPAR CAP STRUCTURE FOR A WIND TURBINE BLADE

(71) Applicants: BLADE DYNAMICS LLLP, New Orleans, LA (US); LM WIND POWER A/S, Kolding (DK)

(72) Inventors: Thomas MERZHAEUSER, Salzbergen (DE); Amir RIAHI, New Orleans, LA (US); Andrew M RODWELL, New Orleans, LA (US)

(21) Appl. No.: 18/019,578

(22) PCT Filed: Aug. 6, 2021
(86) PCT No.: PCT/EP2021/072059

§ 371 Date: Feb. 3, 2023

(30) Foreign Application Priority Data
Aug. 6, 2020 (GB) 2012262.8

(51) Int. Cl. B32B 5/26; B32B 7/022; B32B 5/02; B32B 5/12; B32B 5/06; B32B 37/18; F03D 1/06

(52) U.S. Cl. CPC B32B 5/26; B32B 7/022; B32B 5/024; B32B 5/12; B32B 5/028; B32B 5/073; B32B 37/18; F03D 1/0675; B32B 2260/023; B32B 2260/046; B32B 2250/20; B32B 2307/54; B32B 2603/00; B32B 2262/0276; B32B 2262/106; B32B 2305/18; B32B 2305/076; B32B 2363/00; B32B 2367/00; B32B 2331/00; B32B 2313/04; F05B 2230/30; F05B 2280/6003

(57) ABSTRACT

The present invention relates to a spar cap for a wind turbine blade comprising a plurality of pre-cured fibre-reinforced elements and a plurality of interlayers. The plurality of pre-cured fibre-reinforced elements include a first pre-cured fibre-reinforced element and a second pre-cured fibre-reinforced element and the plurality of interlayers include a first interlayer comprising a first plurality of fibres embedded in a first cured resin. The first interlayer is being arranged between the first pre-cured fibre-reinforced element and the second pre-cured fibre-reinforced element. The first plurality of fibres have a first elastic modulus, the first cured resin has a second elastic modulus, the first and/or second pre-cured fibre-reinforced elements have a third elastic modulus, and the first interlayer has a fourth elastic modulus. The ratio between the first elastic modulus and the second elastic modulus is between 1:4 and 4:1 and/or the ratio between the third elastic modulus and the fourth elastic modulus is between 1:4 and 4:1.

### FIELD OF INVENTION

The present invention relates to a spar cap for a wind turbine blade and a wind turbine blade comprising the spar cap and as well methods for manufacturing the spar cap.

### BACKGROUND OF THE INVENTION

The blades of modern wind turbines capture kinetic wind energy by using sophisticated blade design created to maximise efficiency. A major trend in wind turbine development is the increase in size to reduce the leveraged cost of energy. There is an increasing demand for large wind blades which may exceed 80 metres in length and 4 metres in width. The blades are typically made from a fibre-reinforced polymer material and comprise a pressure side shell half and a suction side shell half. The cross-sectional profile of a typical blade includes an airfoil for creating an air flow leading to a pressure difference between the two sides. The resulting lift force generates torque for producing electricity.

The shell halves of wind turbine blades are usually manufactured using blade moulds. First, a blade gel coat or primer is applied to the mould. Subsequently, fibre reinforcement material is placed into the mould in layers followed by arrangement of other elements within the shell halves, such as core elements, load-carrying spar caps, internal shear webs and the like. The resulting shell halves are resin infused and assembled by being glued or bolted together substantially along a chord plane of the blade.

The spar caps may be laid up directly in the wind turbine blade moulds with the other fibre-reinforcing elements or in a separate offline mould, where they are resin infused and then subsequently lifted into the main blade shell mould, which is then infused with resin.

The spar caps may comprise a plurality of stacked pultruded carbon fibre elements or profiles and interlayers arranged between the pultruded carbon fibre elements. The presence of interlayers between the pultruded profiles are used for infusibility of the stack of pultruded carbon fibre elements with resin. The interlayers normally consist of glass or carbon fibre sheets to provide structural bridging and strength in the gap between neighboring pultrusion profiles. However, the high fibre volume in the interlayers also results in low fracture toughness, which is one of the key aspects of building reliable spar caps for wind turbine blades.

Hence, a spar cap for a wind turbine blade having increased fracture toughness and methods for manufacturing such a spar cap would be advantageous.

### SUMMARY OF INVENTION

It is an object of the present invention to provide a spar cap for a wind turbine blade which at least ameliorates some of the aforementioned problems or provides a useful alternative and/or improved performance over the prior art. Particularly, it is an object of the present disclosure to provide a spar cap for a wind turbine blade having increased fracture toughness compared to the prior art.

The present inventors have found that one or more of said objects may be achieved in a first aspect of the invention relating to a spar cap for a wind turbine blade comprising:
a plurality of pre-cured fibre-reinforced elements, including a first pre-cured fibre-reinforced element and a second pre-cured fibre-reinforced element,
a plurality of interlayers, including a first interlayer comprising a first plurality of fibres embedded in a first cured resin and being arranged between the first pre-cured fibre-reinforced element and the second pre-cured fibre-reinforced element,
wherein the first plurality of fibres have a first elastic modulus, the first cured resin has a second elastic modulus, the first and/or second pre-cured fibre-reinforced elements have a third elastic modulus, and the first interlayer has a fourth elastic modulus;
wherein the ratio between the first elastic modulus and the second elastic modulus is between 1:4 and 4:1 and/or the ratio between the third elastic modulus and the fourth elastic modulus is between 1:4 and 4:1.

The present inventors have found that the fracture toughness of the spar cap increases when the difference between the elastic modulus of the plurality of fibres in the interlayer and the elastic modulus of the first resin decreases. Furthermore, the present inventors have found that the fracture toughness of the spar cap increases when the difference between the elastic modulus of the interlayer and the elastic modulus of the pre-cured fibre-reinforced elements decreases. This may be due to a decrease of internal stress between the different materials in the spar cap and in particular between the very stiff pre-cured fibre-reinforced elements.

Preferably, the elastic modulus of the first plurality of fibres in the interlayer and the first resin should be substantially the same, i.e. have a ratio close to 1:1. In the same way, the elastic modulus of the interlayer and the pre-cured fibre-reinforced elements should be substantially the same. However, in the wind turbine industry, other factors than fracture toughness need to be taken into account, such as structural integrity, adherence properties, price of materials etc. Thus, it may not always be possible to have the first plurality of fibres and a first resin with substantially the same elastic modulus. Regarding the interlayer and the pre-cured fibre-reinforced element, it is even harder to make an optimized design, wherein the third and fourth elastic moduli are substantially the same. However, the present inventors have found that a ratio between the second elastic modulus and the first elastic modulus between 1:4 and 4:1 also increases the fracture toughness of the spar cap compared to prior art, where the interlayers normally comprise carbon fibres or glass fibres having a much higher elastic modulus than the resins typically used in spar caps. Furthermore, a ratio between the third elastic modulus and the fourth elastic modulus between 1:4 and 4:1 also increases the fracture toughness of the spar cap compared to prior art and at the same time allows other factors of the spar cap to be optimized.

In preferred embodiments, the ratio between the first elastic modulus and the second elastic modulus is between 1:3 and 3:1, preferably between 1:2 and 2:1, more preferably between 1:1.5 and 1.5:1, such as 1:1. In some embodiments, the ratio between the third elastic modulus and the fourth elastic modulus is between 1:3 and 3:1, preferably between 1:2 and 2:1, more preferably between 1:1.5 and 1.5:1, such as 1:1.

In some embodiments, the first elastic modulus is between 50% and 200% of the second elastic modulus, such as between 50% and 150%, such as between 70% and 130%, such as between 80% and 120%, such as between 90% and 110%.

In some embodiments, the first and/or second and/or third and/or fourth elastic modulus is less than 10 GPa, such as less than 8 GPa, such as less than 7 GPa, such as less than 6 GPa, preferably less than 5 GPa. In the prior art, interlayers with an elastic modulus above 10 GPa are used in spar caps.

The first and/or second and/or third and/or fourth elastic modulus is above 0, such as above 0.1 GPa, such as above 1 Gpa, such as above 1.5 GPa.

The first elastic modulus is preferably within the range of 0.1 and 10 GPa, such as between 1 and 5 GPa.

In some embodiments, the second elastic modulus is less than 5 GPa.

In some embodiments, the second elastic modulus is between 1-5 GPa, such as between 1.5-4.5 GPa, such as between 2-4 GPa.

In some embodiments, the first elastic modulus is equal to or differs from the second elastic modulus with less than 5 GPa, such as with less than 2 GPa, preferably with less than 1 GPa, such as with less than 0.5 GPa, such as with less than 0.3 GPa, such as with less than 0.2 GPa, such as with less than 0.1 GPa, such as with less than 0.05 GPa, such as with less than 0.025 GPa. In some embodiments, the third elastic modulus is equal to or differs from the fourth elastic modulus with less than 5 GPa, such as with less than 2 GPa, preferably with less than 1 GPa, such as with less than 0.5 GPa, such as with less than 0.3 GPa, such as with less than 0.2 GPa, such as with less than 0.1 GPa, such as with less than 0.05 GPa, such as with less than 0.025 GPa.

In some embodiments, the first cured resin comprises epoxy resin or polyester resin or vinyl ester resin.

In some embodiments, the first interlayer is a fibre sheet comprising one or more layers, wherein each layer is selected from a group consisting of: a unidirectional fabric, a bidirectional fabric or a tridirectional fabric, a veil comprising randomly oriented fibres and a net comprising woven fibres.

One or more of the interlayers may be a unidirectional sheet comprising first fibres all arranged along a first direction. The first interlayer may be a biaxial sheet comprising first fibres arranged along a first direction and second fibres arranged along a second direction, e.g. perpendicularly to the first direction. The first interlayer may also be a triaxial sheet or a sheet comprising randomly arranged fibres.

The first plurality of fibres in each interlayer may be stitched together or held together by binding agent. The binding agent maintain arrangement of the first plurality of fibres relative to each other. Alternatively or additionally, the first plurality of fibres may be stitched or woven together to maintain arrangement of the first plurality of fibres relative to each other.

One or more of the interlayer may be a weaved sheet, i.e. a net comprising one, two or three different types of fibres.

In some embodiments, the first plurality of fibres are polymeric fibres or filaments. The polymeric fibres may be polyester filaments, polypropylene filaments and/or polyethylene filaments. The polymeric filaments may be thermoplastic filaments, such as thermoplastic polyester filaments, thermoplastic polypropylene filaments and/or thermoplastic polyethylene filaments. The use of polymeric filaments in the interlayer promotes resin infusion, provides wetting of the area between carbon pultrusions and reduces the amount of defects. In preferred embodiments, the plurality of first fibres are polyester fibres.

One or more of the interlayers may be a polyester veil or a polyester mesh. A polyester veil is a thin layer of fluffy material essentially consisting of randomly arranged polyester fibres. A polyester veil has high permeability, promotes resin infusion and has good adhesion properties. In preferred embodiments, the first interlayer is a polyester veil or mesh or another open-meshed structure promoting flow of resin.

One or more of the interlayers, including the first interlayer, have a length in a longitudinal direction, a width in a width direction, and a thickness in a thickness direction. The length may be longer than the width and the width may be larger than the thickness. The length may be between 2-150 meters, such as between 4-100 meters. The width may be between 20-200 mm, such as between 50-150 mm, such as 100 mm. The height may be between 2-10 mm, such as 5 mm.

Each of the interlayers further have a lower interlayer surface and an upper interlayer surface extending in the longitudinal direction and the width direction. Each of the interlayers have a first side surface and a second side surface extending in the longitudinal direction and in the thickness direction. Each of the interlayers further have a first end surface and a second end surface extending in the width direction and the thickness direction.

The upper interlayer surface and the lower interlayer surface may be defined as the two largest surfaces of the interlayer sheet. The upper interlayer surface may be opposite the lower interlayer surface.

In some embodiments, the plurality of pre-cured fibre-reinforced elements comprise reinforcement fibres and a second cured resin. Preferably, the reinforcement fibres are carbon fibres. In some embodiments, the plurality of pre-cured fibre-reinforced elements are pultruded elements, such as carbon pultrusion planks comprising carbon fibres and a second cured resin. In some embodiments, the plurality of pre-cured fibre-reinforced elements are extruded elements comprising carbon fibres and a second cured resin.

One or more of the pre-cured fibre-reinforced elements, including the first pre-cured fibre-reinforced element and/or the second pre-cured fibre-reinforced element, may have a length in a longitudinal direction, a width in a width direction, and a thickness in a thickness direction. The length may be longer than the width and the width may be larger than the thickness. The length may be between 2-150 meters, such as between 4-100 meters. The width may be between 20-200 mm, such as between 50-150 mm, such as 100 mm. The height may be between 2-10 mm, such as 5 mm.

Each of the plurality of pre-cured fibre-reinforced elements may have a lower surface and an upper surface extending in the longitudinal direction and the width direction. Each of the plurality of pre-cured fibre-reinforced elements may have a first side surface and a second side surface extending in the longitudinal direction and the thickness direction. Each of the plurality of pre-cured fibre-reinforced elements, such as each of the plurality pultruded carbon elements, may have a first end surface and a second end surface extending in the width direction and the thickness direction.

The first pre-cured fibre-reinforced element and the second pre-cured fibre-reinforced element may be arranged such that the lower surface of the first pre-cured fibre-reinforced element is facing the upper surface of the second pre-cured fibre-reinforced element. The interlayer may be arranged between the lower surface of the first pre-cured fibre-reinforced element and the upper surface of the second pre-cured fibre-reinforced element, such that the upper or lower interlayer surface is facing the lower surface of the first cured fibre-reinforced element and the upper or lower interlayer surface is facing the upper surface of the second pre-cured fibre-reinforced element.

The spar cap preferably comprises plurality of pre-cured fibre-reinforced elements arranged in an array comprising a plurality of rows of pre-cured fibre-reinforced elements arranged on top of each other. Each row comprise a plurality of pre-cured fibre-reinforced elements arranged adjacent to each other. The rows are separated by one or more interlayers.

The interlayers may be arranged between the pre-cured fibre-reinforced elements in a width direction (horizontal) and/or between elements in a thickness direction (vertical). The first pre-cured fibre-reinforced element and the second pre-cured fibre-reinforced element may be adjacent elements in the thickness direction or in the width direction.

The first and/or second and/or third and/or fourth elastic modulus may be determined by any known method of determining the elastic modulus of a material. Since the inventive idea of the invention lies in the differences between elastic moduli of different elements of the spar cap, it is important that the elastic modulus of the different elements is determined with the same method.

The first elastic modulus, i.e. the elastic modulus of the first plurality of fibres in the first interlayer, is preferably measured in a length direction of the first plurality of fibres, i.e. the first elastic modulus is preferably a fibre material constant. Thus, the first elastic modulus should be measured for a sample comprising one or more of the first plurality of fibres in the longitudinal direction of the first plurality of fibres, before the first plurality of fibres are arranged in the interlayer.

The second elastic modulus, i.e. the elastic modulus of the first resin, should be measured for a sample of cured first resin, before the first plurality of fibres are embedded in the first resin. Since resin is a substantially isotropic material, the second elastic modulus may be measured in any direction of the cured resin.

The third elastic modulus, i.e. the elastic modulus of the interlayer comprising the first plurality of fibres embedded in the first cured resin, should be measured for a sample of the interlayer in a thickness direction.

The fourth elastic modulus, i.e. the elastic modulus of the first and/or second pre-cured fibre-reinforced elements, should be measured for a sample of the first and/or second pre-cured fibre-reinforced elements in a thickness direction.

There are several different tests such as the 3 point test, or a stretch test to determine the elastic modulus of a material. Essentially a sample is prepared, and a force is applied to it, and the deflection or stretch is measured. Attention needs to be paid to the sample preparation, conditions (such as temperature), matrix and density of fibres and/or weave, such that the elastic modulus of the samples assembles that of the interlayer and cured resin used in the spar cap in use. Accordingly, the provided elastic modulus is also provided at 20 degrees Celsius.

In a second aspect, the invention relates to a wind turbine blade comprising a blade shell with a spar cap according to the first aspect of the present invention integrally formed with or attached to the blade shell.

The wind turbine blade may comprise two spar caps according to the spar cap as disclosed herein. For example, the wind turbine blade may comprise a first spar cap in a first blade shell part and a second spar cap in a second blade shell part. The first spar cap may be a pressure side spar cap of a pressure side blade shell part. The second spar cap may be a suction side spar cap of a suction side blade shell part.

In some embodiments, the wind turbine blade according comprising a first spar cap integrally formed with or attached to a pressure side of the blade, a second spar cap integrally formed with or attached to a suction side of the blade, and one or more shear webs connected between first spar cap and the second spar cap.

In a third aspect, the present invention relates to a method of manufacturing spar cap comprising the steps of:
a) providing a plurality of pre-cured fibre-reinforced elements including a first pre-cured fibre-reinforced element (30) and a second pre-cured fibre-reinforced element (40);
b) providing a plurality of interlayers, including a first interlayer (20) comprising a first plurality of fibres,
c) arranging the first interlayer (20) in between the first pre-cured fibre-reinforced element (30) and the second pre-cured fibre-reinforced element (40) such that the pre-cured fibre-reinforced elements (30,40) are separated by the first interlayer (20);
d) infusing a first resin between the plurality of pre-cured fibre-reinforced elements and the plurality of interlayers;
e) curing the resin in order to form the spar cap (10),

wherein the first plurality of fibres (20) have a first elastic modulus, the first cured resin has a second elastic modulus, the first and/or second pre-cured fibre-reinforced elements (40) have a third elastic modulus, and the first interlayer (20) has a fourth elastic modulus;

wherein the ratio between the first elastic modulus and the second elastic modulus is between 1:4 and 4:1 and/or the ratio between the third elastic modulus and the fourth elastic modulus is between 1:4 and 4:1.

In some embodiments, the plurality of pre-cured fibre-reinforced elements are provided as pultruded elements, extruded elements or otherwise pre-fabricated elements.

Pultruded elements may be provided by a pultrusion process where the reinforcement materials like fibres or woven or braided strands are impregnated with a second possibly followed by a separate preforming system, and pulled through a heated stationary where the resin undergoes polymerization. The impregnation is either done by pulling the reinforcement through a bath or by injecting the second resin into an injection chamber which typically is connected to the die. Many resin types may be used in pultrusion including polyester, polyurethane, vinylester and epoxy.

Extruded elements may be provided by an extrusion process.

In some embodiments, step c) of manufacturing a spar cap includes arranging the plurality of pre-cured fibre-reinforced elements and interlayers in a pre-form mould.

In some embodiments, step c) of manufacturing a spar cap includes arranging the plurality of pre-cured fibre-reinforced elements and interlayers in a wind turbine blade mould.

In some embodiments, step d) includes covering the plurality of pre-cured fibre reinforced elements and interlayers in the pre-form mould with a cover, such as a vacuum bag, to form a mould cavity and supplying the first resin into the mould cavity.

In some embodiments, step d) includes covering the wind turbine blade mould with a cover, such as a vacuum bag, to form a mould cavity and supplying the first resin into the mould cavity.

The step of infusing the blade mould cavity with resin is preferably based on vacuum assisted resin transfer moulding (VARMT). When the desired elements have been arranged in the pre-form mould or wind turbine blade mould, a vacuum bag may be arranged on top of the elements arranged on the moulding surface and the vacuum bag may be sealed against the blade mould. Then the blade mould cavity within the sealed vacuum bag may be infused with resin. Optionally, the step of resin infusion is followed by curing.

In some embodiments, the first cured resin and the second cured resin are of the same type, i.e. the cured resin of the pre-cured fibre-reinforced elements are the same type as the cured resin embedding the pre-cured fibre-reinforced elements and the interlayers between the pre-cured fibre-reinforced elements.

In other embodiments, the first cured resin and the second cured resin are different types of resin.

In a third aspect, the present invention relates to a method of manufacturing a wind turbine blade according to the present invention, including the steps of manufacturing a pressure side shell half and a suction side shell half over substantially the entire length of the wind turbine blade and subsequently closing and joining the shell halves for obtaining a closed shell, wherein manufacturing the pressure side shell half or the suction side shell half comprise the steps of:
providing a blade mould for a blade shell member, the blade mould comprising a moulding surface;
arranging a number of fibre-reinforced layers on the blade moulding surface;
providing a pre-manufactured spar cap according to the first aspect of the present invention and arranging the pre-manufactured spar cap on the fibre-reinforced layers in the blade mould; or
stacking a plurality of pre-cured fibre-reinforced elements on the fibre-reinforced layers in the blade mould, wherein an interlayer comprising a first plurality of fibres is arranged between each fibre-reinforced element;
covering the plurality of pre-cured fibre-reinforced elements and interlayers in the blade mould with a cover to form a cavity and infusing the cavity with a first resin;
optionally curing the resin to form the blade shell member

wherein the first plurality of fibres (20) have a first elastic modulus, the first cured resin has a second elastic modulus, the first and/or second pre-cured fibre-reinforced elements (40) have a third elastic modulus, and the first interlayer (20) has a fourth elastic modulus;

wherein the ratio between the first elastic modulus and the second elastic modulus is between 1:4 and 4:1 and/or the ratio between the third elastic modulus and the fourth elastic modulus is between 1:4 and 4:1.

Again, the step of infusing the blade mould cavity with resin may be based on vacuum assisted resin transfer moulding (VARMT).

It will be understood that any of the above-described features may be combined in any embodiment of the invention. In particular, embodiments described with regard to the spar cap may also apply to the wind turbine blade and vice versa. Furthermore, the embodiments described with regard to the spar cap and wind turbine blade may also apply to the method of manufacturing a spar cap or wind turbine blade and vice versa.

### DETAILED DESCRIPTION OF THE INVENTION

Embodiments of the disclosure will be described in more detail in the following with regard to the accompanying figures. The figures show one way of implementing the present disclosure and are not to be construed as being limiting to other possible embodiments falling within the scope of the attached claim set.

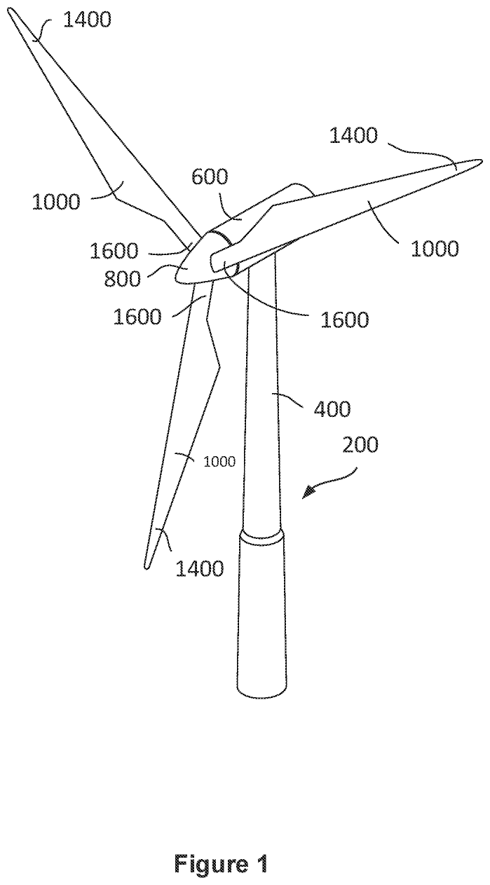

FIG. 1 is a schematic diagram illustrating a wind turbine,

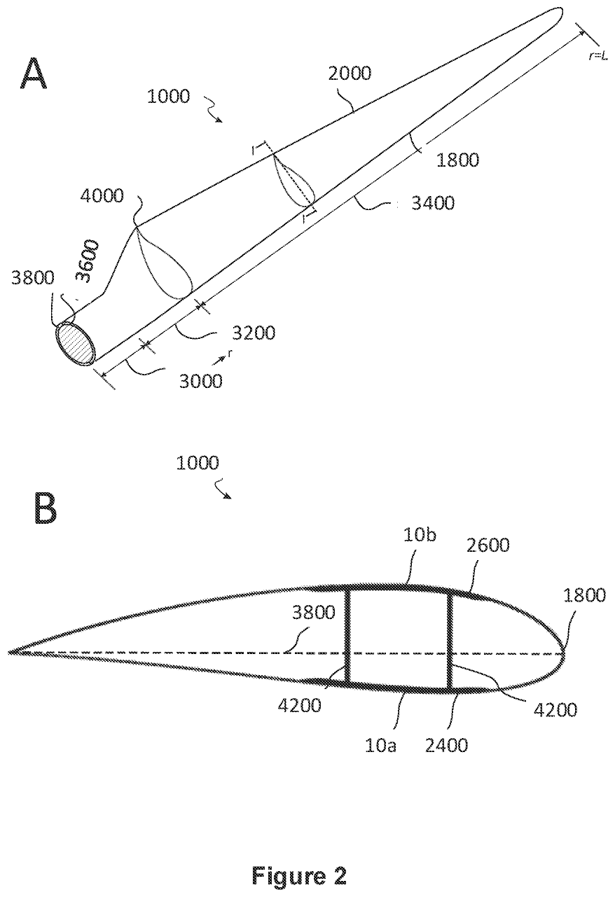

FIG. 2 is a schematic diagram illustrating a wind turbine blade and a spar cap structure arranged within the wind turbine blade,

and

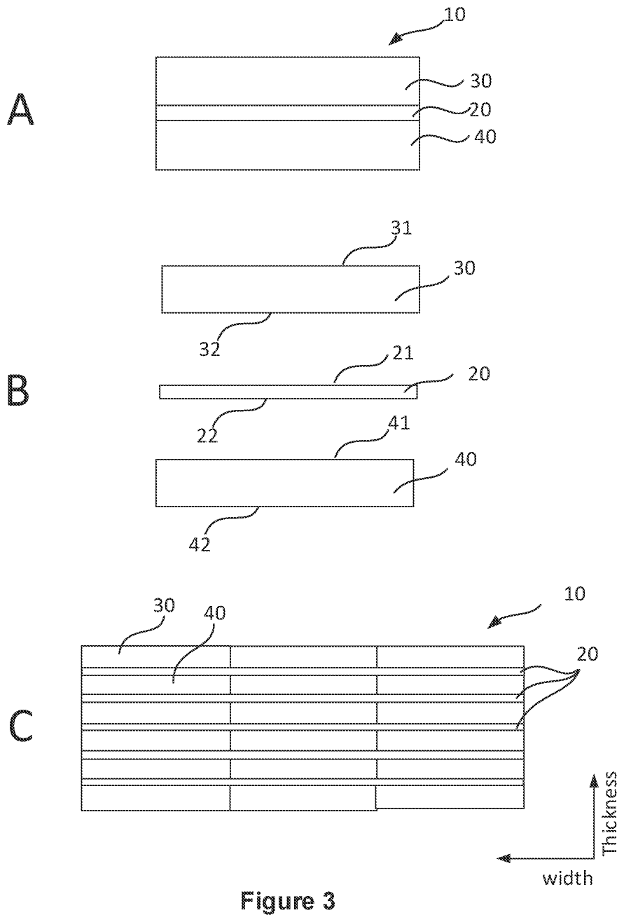

FIG. 3 is a schematic diagram illustrating a cross-sectional view of a spar cap comprising an interlayer arranged between pre-cured fibre-reinforced elements.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

FIG. 1 illustrates a conventional modern upwind wind turbine according to the so-called “Danish concept” with a tower 400, a nacelle 600 and a rotor with a substantially horizontal rotor shaft. The rotor includes a hub 800 and three blades 1000 extending radially from the hub 800, each having a blade root 1600 nearest the hub and a blade tip 1400 furthest from the hub 800.

FIG. 2A shows a schematic view of a first embodiment of a wind turbine blade 1000. The wind turbine blade 1000 has the shape of a conventional wind turbine blade and comprises a root region 3000 closest to the hub, a profiled or an airfoil region 3400 furthest away from the hub and a transition region 3200 between the root region 3000 and the airfoil region 3400. The blade 1000 comprises a leading edge 1800 facing the direction of rotation of the blade 1000, when the blade is mounted on the hub, and a trailing edge 2000 facing the opposite direction of the leading edge 1800.

The airfoil region 3400 (also called the profiled region) has an ideal or almost ideal blade shape with respect to generating lift, whereas the root region 3000 due to structural considerations has a substantially circular or elliptical cross-section, which for instance makes it easier and safer to mount the blade 1000 to the hub. The diameter (or the chord) of the root region 3000 may be constant along the entire root area 3000. The transition region 3200 has a transitional profile gradually changing from the circular or elliptical shape of the root region 3000 to the airfoil profile of the airfoil region 3400. The chord length of the transition region 3200 typically increases with increasing distance r from the hub. The airfoil region 3400 has an airfoil profile with a chord extending between the leading edge 1800 and the trailing edge 2000 of the blade 1000. The width of the chord decreases with increasing distance r from the hub.

A shoulder 4000 of the blade 1000 is defined as the position, where the blade 1000 has its largest chord length. The shoulder 4000 is typically provided at the boundary between the transition region 3200 and the airfoil region 3400.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

FIG. 2B is a schematic diagram illustrating a cross sectional view of an exemplary wind turbine blade 1000, e.g. a cross-sectional view of the airfoil region of the wind turbine blade 1000. The wind turbine blade 1000 comprises a leading edge 1800, a trailing edge 2000, a pressure side 2400, a suction side 2600, a first spar cap 10a, and a second spar cap 10b. The wind turbine blade 1000 comprises a chord line 3800 between the leading edge 1800 and the trailing edge 2000. The wind turbine blade 1000 comprises shear webs 4200, such as a leading edge shear web and a trailing edge shear web. The shear webs 4200 could alternatively be a spar box with spar sides, such as a trailing edge spar side and a leading edge spar side. The spar caps 10a, 10b may comprise carbon fibres, while the rest of the shell parts 2400, 2600 may comprise glass fibres.

FIG. 3A is a schematic diagram illustrating a cross sectional view of an interlayer 20 arranged between a first and a second pre-cured fibre-reinforced element 30, 40, such as a first pultruded carbon fibre element and a second pultruded carbon fibre element. The interlayer and pre-cured fibre-reinforced elements each have a length in a longitudinal direction, a width in a width direction, and a thickness in a thickness direction. The length is longer than the width and the width is larger than the thickness. In FIG. 3A, the width and thickness of the interlayer and pre-cured fibre-reinforced elements can be seen, but not in the length. The first and second pre-cured fibre-reinforced elements 30, 40 and the interlayer 20 may form part of a spar cap 10 arranged in a wind turbine blade, such as the spar caps 10a, 10b of the wind turbine blade 1000 as illustrated in FIG. 2.

FIG. 3B is a schematic diagram illustrating an exploded view of the interlayer 20 arranged between the first and second pre-cured fibre reinforced elements 30, 40. The interlayer 20, in the illustrated example, is an interlayer sheet having an upper interlayer surface 21 and a lower interlayer surface 22. In the same way, the first pre-cured fibre-reinforced element 30 has a first upper surface 31 and a first lower surface 32 and the second pre-cured fibre-reinforced element 40 has a second upper surface 41 and a second lower surface 42.

The first pre-cured fibre-reinforced element 30 and the second pre-cured fibre-reinforced element 40 are arranged such that the first lower surface 32 of the first pre-cured fibre-reinforced element 50 is facing the second upper surface 41 of the second pre-cured fibre-reinforced element 40. The interlayer 20 is arranged between the lower surface 32 of the first pre-cured fibre-reinforced element 30 and the upper surface 41 of the second pre-cured fibre-reinforced element 40, e.g. such that the upper interlayer surface 21 is in contact with the first lower surface 32 and the lower interlayer surface 22 is in contact with the second upper surface 41.

FIG. 3C is a schematic diagram illustrating a cross-sectional view of a fibre reinforced composite material, e.g. spar cap 10 or part of a spar cap, comprising a plurality of pre-cured fibre-reinforced elements, such as pultruded carbon fibre elements, including a first pre-cured fibre-reinforced element 30 and a second pre-cured fibre-reinforced element 40. The plurality of pre-cured fibre-reinforced elements 30, 40 are arranged in an array with three rows of pre-cured fibre-reinforced elements arranged adjacent to each other. Each row comprise three pre-cured fibre-reinforced elements arranged adjacent to each other. The rows are separated by an interlayer 20. It is of course clear that the spar cap 10 may comprise other number of layers and juxtaposed pre-cured fibre-reinforced elements.

The fibre-reinforced composite material may form part of a spar cap arranged in a wind turbine blade 1000, such as the spar caps 10a, 10b of the wind turbine blade 1000 as illustrated in FIG. 2. Although not specifically illustrated, interlayers may also be provided between adjacent elements in the width direction, to facilitate resin flow between elements also in this direction.

### LIST OF REFERENCE NUMERALS

200 wind turbine
400 tower
600 nacelle
800 hub
1000 blade
1400 blade tip
1600 blade root
1800 leading edge
2000 trailing edge
2200 pitch axis
2400 pressure side
2600 suction side
3000 root region
3200 transition region
3400 airfoil region
4000 shoulder/position of maximum chord
4200 shear web
10 spar cap
10a first spar cap
10b second spar cap
20 interlayer
21 upper interlayer surface
22 lower interlayer surface
30 first pre-cured fibre-reinforced element
31 first upper surface
32 first lower surface
40 second pre-cured fibre-reinforced element
41 second upper surface
42 second lower surface

1. Spar cap (10) for a wind turbine blade comprising:
a plurality of pre-cured fibre-reinforced elements, including a first pre-cured fibre-reinforced element (30) and a second pre-cured fibre-reinforced element (40);
a plurality of interlayers, including a first interlayer (20) comprising a first plurality of fibres embedded in a first cured resin and being arranged between the first pre-cured fibre-reinforced element (30) and the second pre-cured fibre-reinforced element (40);
wherein the first plurality of fibres (20) have a first elastic modulus, the first cured resin has a second elastic modulus, the first and/or second pre-cured fibre-reinforced elements (40) have a third elastic modulus, and the first interlayer (20) has a fourth elastic modulus;
wherein the ratio between the first elastic modulus and the second elastic modulus is between 1:4 and 4:1 and/or the ratio between the third elastic modulus and the fourth elastic modulus is between 1:4 and 4:1.

2. Spar cap (10) according to claim 1, wherein the ratio between the first elastic modulus and the second elastic modulus is between 1:3 and 3:1, preferably between 1:2 and 2:1, more preferably between 1:1.5 and 1.5:1, such as 1:1 and/or the ratio between the third elastic modulus and the fourth elastic modulus is between 1:3 and 3:1, preferably between 1:2 and 2:1, more preferably between 1:1.5 and 1.5:1, such as 1:1.

3. Spar cap (10) according to claim 1, wherein the first and/or second and/or third and/or fourth elastic modulus is less than 10 GPa, such as less than 8 GPa, such as less than 7 GPa, such as less than 6 GPa, preferably less than 5 GPa.

4. Spar cap (10) according to claim 1, wherein the second elastic modulus is between 1-5 GPa, such as between 1.5-4.5 GPa, such as between 2-4 GPa.

5. Spar cap (10) according to claim 1, wherein the first elastic modulus is equal to or differs from the second elastic modulus with less than 5 GPa, such as with less than 2 GPa, preferably with less than 1 GPa, such as with less than 0.5 GPa, such as with less than 0.3 GPa, such as with less than 0.2 GPa, such as with less than 0.1 GPa, such as with less than 0.05 GPa, such as with less than 0.025 GPa.

6. Spar cap (10) according to claim 1, wherein the third elastic modulus is equal to or differs from the fourth elastic modulus with less than 5 GPa, such as with less than 2 GPa, preferably with less than 1 GPa, such as with less than 0.5 GPa, such as with less than 0.3 GPa, such as with less than 0.2 GPa, such as with less than 0.1 GPa, such as with less than 0.05 GPa, such as with less than 0.025 GPa.

7. Spar cap (10) according to claim 1, wherein the first cured resin comprises epoxy resin or polyester resin or vinyl ester resin.

8. An interlayer sheet (20) according to claim 1, wherein the first interlayer is a fibre sheet comprising one or more layers, wherein each layer is selected from a group consisting of: a unidirectional fabric, a bidirectional fabric or a tridirectional fabric, a veil comprising randomly oriented fibres and a net comprising woven fibres.

9. An interlayer sheet (20) according to claim 1, wherein the fibres in the first fibre layer (30) and/or the second fibre layer (40) and/or third fibre layer (50) are maintained relative to each other and/or the other fibre layers by a binding agent or are stitched together by a thread.

10. Spar cap (10) according to claim 1, wherein the first plurality of fibres are polymeric fibres, preferably polyester fibres.

11. Spar cap (10) according to claim 1, wherein the interlayer (20) is a polyester veil or a polyester mesh.

12. Spar cap (10) according to claim 1, wherein the plurality of pre-cured fibre-reinforced elements are pultruded elements, such as carbon pultrusion planks comprising carbon fibres and a second cured resin.

13. Spar cap (10) according to claim 1, wherein the first cured resin and the second cured resin is the same type or a different type of resin.

14. Wind turbine blade (1000) comprising a blade shell with a spar cap (10) according to claim 1 integrally formed with or attached to the blade shell.

15. Wind turbine blade (1000) according to claim 14 comprising a first spar cap (10a) integrally formed with or attached to an pressure side (2400) of the blade, a second spar cap (10b) integrally formed with or attached to a suction side (2600) of the blade (1000), and one or more shear webs (4200) connected between first spar cap (10a) and the second spar cap (10b).

16. Method of manufacturing spar cap (10) according to claim 1, comprising the steps of:
a) providing a plurality of pre-cured fibre-reinforced elements including a first pre-cured fibre-reinforced element (30) and a second pre-cured fibre-reinforced element (40);
b) providing a plurality of interlayers, including a first interlayer (20) comprising a first plurality of fibres;
c) arranging the first interlayer (20) in between the first pre-cured fibre-reinforced element (30) and the second pre-cured fibre-reinforced element (40) such that the pre-cured fibre-reinforced elements (30,40) are separated by the first interlayer (20);
d) infusing a first resin between the plurality pre-cured fibre-reinforced elements and the plurality of interlayers;
e) curing the resin in order to form the spar cap (10);
wherein the first plurality of fibres (20) have a first elastic modulus, the first cured resin has a second elastic modulus, the first and/or second pre-cured fibre-reinforced elements (40) have a third elastic modulus, and the first interlayer (20) has a fourth elastic modulus;
wherein the ratio between the first elastic modulus and the second elastic modulus is between 1:4 and 4:1 and/or the ratio between the third elastic modulus and the fourth elastic modulus is between 1:4 and 4:1.
